(19) United States
(12) Patent Application Publication
(10) Pub. No.: US 2026/0202027 A1
(43) Pub. Date: Jul. 16, 2026

(54) AUTOMOTIVE HEADLIGHTING WITH IMPROVED VISIBILITY

(71) Applicant: LUMILEDS LLC, San Jose, CA (US)

(72) Inventor: Ralph BERTRAM, Herzogenrath (DE)

(73) Assignee: LUMILEDS LLC, San Jose, CA (US)

(21) Appl. No.: 19/138,205

(22) PCT Filed: Jan. 18, 2024
(86) PCT No.: PCT/US2024/012009

§ 371 Date: Jun. 12, 2025

Related U.S. Application Data
(60) Provisional application No. 63/439,798, filed on Jan. 18, 2023.

(51) Int. Cl. F21S 41/141; F21S 41/13; F21S 41/19

(52) U.S. Cl. CPC F21S 41/141; F21S 41/13; F21S 41/192

(57) ABSTRACT

LED devices and methods of operating them are described. An LED lighting device includes a substrate (702), a white LED (402) on the substrate at a location configured for alignment with an optical axis of an automotive lamp when installed, and a near ultraviolet LED (404) on the substrate at a location spaced apart from the white LED by an amount such that the near ultraviolet LED is defocused from the optical axis of the automotive lamp when installed such that the near ultraviolet LED emits energy in the near ultraviolet band in a larger area than the white LED when powered on.

### CROSS-REFERENCE TO RELATED APPLICATIONS

This application claims the benefit of U.S. Provisional Application No. 63/439,798, filed Jan. 18, 2023, the contents of which are incorporated herein by reference.

### BACKGROUND

When illuminated by daylight, untreated white items, such as fabrics made from natural fibers, tend to appear yellow or ivory to the naked eye. These fibers absorb the blue content of incident white light, resulting in a reflected light that appears yellowish. To make these fabrics appear more true white to the human eye, designers may incorporate Fluorescent Whitening Agents (FWAs) into dyes, inks and even laundry detergent to brighten them. These agents may absorb photons with wavelengths in the near ultraviolet, violet, and deep blue spectrum, which are difficult for the human eye to see. The energy of the absorbed photons may be re-emitted by the fabric in the form of photons with longer wavelengths, typically in the blue spectrum. By incorporating FWAs into fabrics, designers can compensate for the natural deficiency of the blue spectral content in reflected light from white fabrics.

Besides clothing, FWAs or other fluorescent agents have been used in other applications to make objects more noticeable under near ultraviolet, violet and/or deep blue spectrum. By way of example, in some locations, such agents may be added to road surface lines and street signs to make them more visible when illuminated. It is also becoming more common for people who are out jogging or walking at night to wear a vest that includes FWAs or substances that in a similar way emit yellow, green, or red-enhanced light. Similar vests are typically worn by safety professionals, such as police officers and crossing guards, as well as construction workers who may be working on or near streets.

Given the increasing use of FWAs and other fluorescent agents in objects to make them visible at night, it would be desirable if they could be better activated on or near roadways to enable a driver to better see them. However, conventional automotive lighting does not have sufficient spectral content to activate the fluorescent agents to make these objects appear more visible to the driver. Outside the area illuminated by the main headlights, even these objects are barely visible.

### SUMMARY

LED devices and methods of operating them are described. An LED lighting device includes a substrate, a white LED on the substrate at a location configured for alignment with an optical axis of an automotive lamp when installed, and a near ultraviolet LED on the substrate at a location spaced apart from the white LED by an amount such that the near ultraviolet LED is defocused from the optical axis of the automotive lamp when installed such that the near ultraviolet LED emits energy in the near ultraviolet band in a larger area than the white LED when powered on.

### BRIEF DESCRIPTION OF THE DRAWINGS

FIG. 1 is a graph showing absorption and emission behavior of a typical whitening agent;

FIG. 2 is a graph showing the normalized spectral power distribution (SPD) for a conventional LED, an LED with a deep blue emission range and a conventional Ceramic Metal Halide (CDM) light;

FIG. 3(a) is a diagram of an example automotive lighting system incorporating separate white and near ultraviolet LEDs using separate first optics (e.g., Total Internal Reflection (TIR) lenses) for the LEDs and a common second optic;

FIG. 3(b) is a diagram of another example automotive lighting system incorporating separate white and near ultraviolet LEDs using the same reflector;

FIG. 3(c) is a diagram of another example automotive lighting system using separate reflectors;

FIG. 4 is a diagram of an example retrofit lamp to replace a single filament lamp in an automotive headlamp incorporating a separate near ultraviolet LED in addition to the white LED;

FIG. 5 is a diagram of an example retrofit lamp to replace a double filament lamp in an automotive headlamp, which may incorporate a separate near ultraviolet LED (not shown) in addition to the white LEDS;

FIG. 6 is a diagram of an example near ultraviolet and white light emitting LED;

FIG. 7 is a diagram of another example near ultraviolet and white light emitting LED;

FIG. 9 is a diagram of an example vehicle headlamp system; and FIG. 9 is a flow diagram of a method of operating an LED lighting system such as the system of FIG. 3(a), 3(b), 3(c), 4 or 5.

### DETAILED DESCRIPTION OF THE PREFERRED EMBODIMENTS

Examples of different light illumination systems and/or light emitting diode (“LED”) implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

The terms ultraviolet, near ultraviolet and deep blue may be referred to herein. As used herein, ultraviolet is intended to refer to a spectrum of light in a range between 250 nm to 400 nm wavelength, for example as defined in UN ECE R112 for automotive headlamps. Near ultraviolet is intended to refer to a spectrum of light in a range between 400 nm and 420 nm wavelength, deep blue is intended to refer to a spectrum of light in a range between 420 and 440 nm wavelength, and blue is intended to refer to a spectrum in a range between 440 and 495 nm wavelength. These terms are typically used similar to how the spectrum is defined herein; however, the spectrum ranges are often commonly defined somewhat differently with the different ranges potentially overlapping somewhat. For purposes of this description, all of the examples are described with respect to the near ultraviolet range. However, one of ordinary skill in the art will understand that near ultraviolet, ultraviolet and deep blue emission ranges may all activate FWAs or other fluorescent agents and thus may be used interchangeably where appropriate.

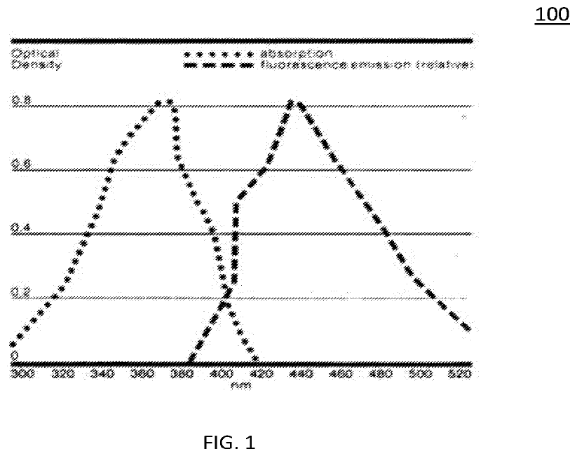

FIG. 1 is a graph 100 showing absorption and emission behavior of a typical whitening agent. As can be seen in the example illustrated in FIG. 1, FWAs absorb ultraviolet, near ultraviolet and deep blue light (e.g., as shown in in FIG. 1, in a range of 300 nm-420 nm wavelength) and re-emit the absorbed energy as longer wavelength photons in the blue spectrum that are visible to the human eye. Natural sunlight includes some near ultraviolet light and, thus, sunlight reflected from objects containing FWAs may contain sufficient blue light to make them appear more white or slightly more visible to the human eye. Conventional white LEDs, however, do not have sufficient spectral content in the deep blue and near ultraviolet ranges to activate FWAs and other fluorescent agents.

Automotive headlights are subject to very strict regulations, for example in terms of the brightness and amount of visible light emitted as, otherwise, such headlights could cause glare to an opposing driver, creating a potentially dangerous situation for the driver and other users of the road. Some spectrum in the non-visible ranges is or may be regulated as well as it can be dangerous to humans over a certain amount (e.g., UV-A, UV-B and UV-C spectrum). However, there is currently no regulation for near ultraviolet light, which does not fall into any regulated bands. Since the eye sensitivity (defined by the V(A) curve) is almost zero in the near ultraviolet region, there are effectively no practical limits for how much near ultraviolet light can be emitted by headlights. Accordingly, embodiments are described herein that incorporate near ultraviolet light along with the typical white light to enhance the user's driving experience as, in addition to visibly lighting the road so the user can see what is near or in front of him or her, such headlights will cause clothing and other objects that contain some type of fluorescent agent to appear to be glowing to the human eye such that the driver can see them better and sooner and react more quickly.

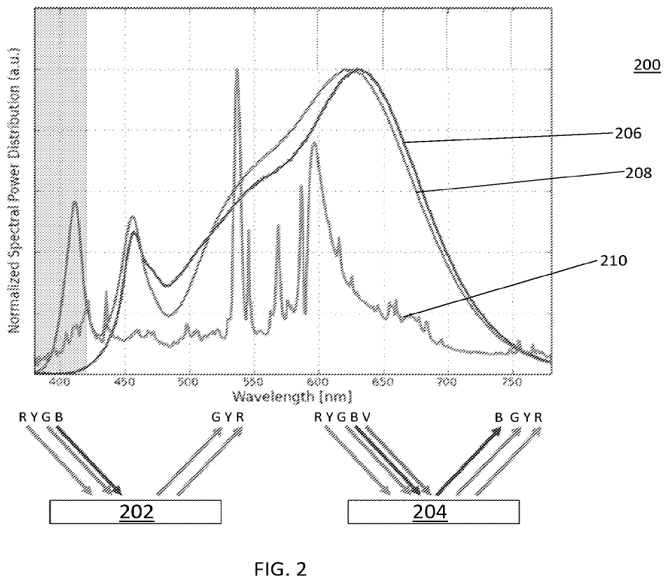

FIG. 2 is a graph showing the normalized spectral power distribution (SPD) for a conventional LED 206, an LED with a deep blue emission range 208 and a conventional Ceramic Metal Halide (CDM) light 210 as well as the emission spectrum from an object containing fluorescent agents when illuminated by an LED with a deep blue emission range. CDM lights are, for example, conventionally used in stores to activate the FWAs in clothing to make the clothing appear more attractive to consumers. As can be seen in FIG. 2, the SPD 208 of the LED with the deep blue emission range is characterized by a double peak in the blue region. Only light sources with sufficient deep blue, ultraviolet or near ultraviolet content (the gray region in the graph in FIG. 2) can activate the fluorescent agents in objects, resulting in a more visible (more white or glowing) appearance that can assist drivers in seeing them better.

Additionally, as mentioned above, FIG. 2 shows the emission spectrum from an object containing fluorescent agents when illuminated by an LED with a deep blue emission range. As can be seen, an object 202 containing fluorescent agents illuminated by a spectrum of light containing red (R), yellow (Y), green (G) and blue (B) components may emit light having green, yellow and red components (no or insufficient blue) while an object 204 illuminated by a spectrum of light containing red, yellow, green, blue and violet (V) (which can be ultraviolet, near ultraviolet or deep blue as defined above) may emit light having the green, yellow and red components emitted by the object 204 as well as blue components that are not part of the spectrum of light emitted by the object 202.

As mentioned, headlamps are heavily regulated to include limits on their glare, yet the only way to enhance visibility of pedestrians on roadways, in the absence of static street lighting, may be to make the headlamps brighter. However, there are practically no limits on the amount of “invisible” (i.e., ultraviolet, near ultraviolet, deep blue, infrared, near infrared, etc.) light that headlamps can emit so long as the amount and spectrum chosen are within safe levels for human exposure. Additionally, while conventional headlamps are regulated in terms of where visible light can be projected, no such limitations exist on “invisible” light. If adequately directed by appropriate optics, LEDs emitting in the near ultraviolet range may be added in addition to the white LEDs and broadened as much as possible so as to emit the widest band of “invisible” light possible. This enables any FWAs or fluorescent agents that are in the vicinity of a vehicle to be activated so that the driver can see them, even in locations where a typical white headlamp beam cannot legally be illuminated. Thus, such headlamps can provide a high level of barely-visible photon flux without generating excessive luminous flux on the road.

There are a number of different ways to integrate the near ultraviolet LEDs into a headlamp system depending on the application. For example, the near ultraviolet LEDs can be mounted below a wavelength converting element such as containing one or more phosphors, together with blue emitting LEDs, or completely separated in different packages. The LEDs in the headlamps can use either a common optical system with the main headlamp or a separate optical system. It is even possible to implement near ultraviolet LEDs in an LED retrofit bulb to replace a halogen light source. The near ultraviolet light generated by the headlamps described herein may be partly converted by fluorescent agents in textiles or road markings, for example, to emit light with a higher perceived brightness (e.g., green-yellow part of spectrum), thus enhancing the visibility of the objects to the driver.

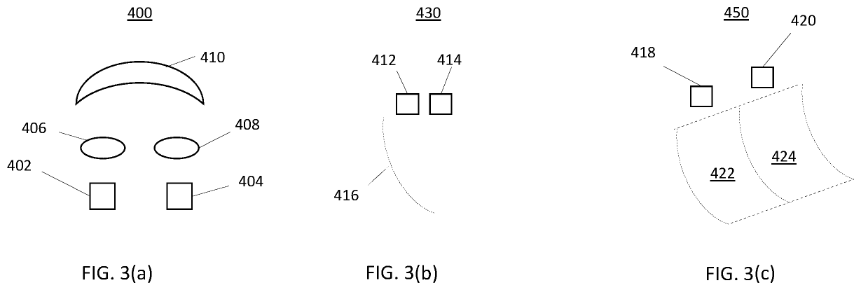

FIG. 3(a) is a diagram of an example automotive lighting system 400 incorporating separate white LEDs 402 and near ultraviolet LEDs 404 using separate first optics 406 and 408 for the LEDS and a common second optic 410. In the example illustrated in FIG. 3(a) the LED 404 is a near ultraviolet pumped LED, and the LED 402 is a blue-pumped LED. The near ultraviolet pumped LED 404 may include one or more near ultraviolet pumped LEDs and/or some combination of near ultraviolet LEDs and white LEDs. The first optics 406 and 408 may be total internal reflection (TIR) lenses. In such embodiment, it is possible to use the existing first and second optics or to change them out with specially designed optics. If the existing primary optics are used, the near ultraviolet LEDs can be incorporated into the LEDs used for high beams and, thus, the near ultraviolet light emitted by the headlamp will be projected out in the widest possible beam using the existing optics while enabling the white LEDs to still be used to create a visible high beam as well. In some embodiments, the white lights can be turned off and only the near ultraviolet lights can be turned on and activated, allowing the optics for the high beam to be used to further enhance visibility even when the high beams are not in use. If a different optic is used for the near ultraviolet LED, it may be possible to widen the beam that includes the near ultraviolet spectrum even further, using optics designed for that purpose that may enable the near ultraviolet light to be spread even to areas where visible light is prohibited.

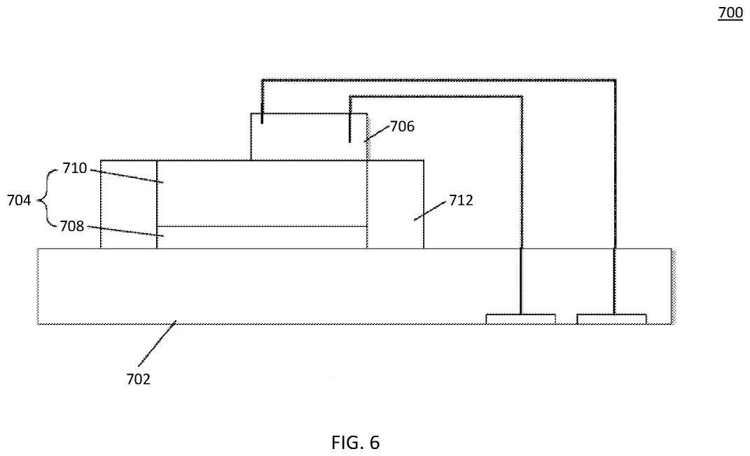

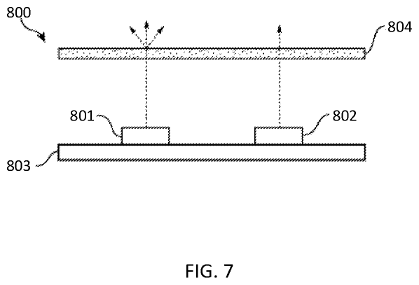

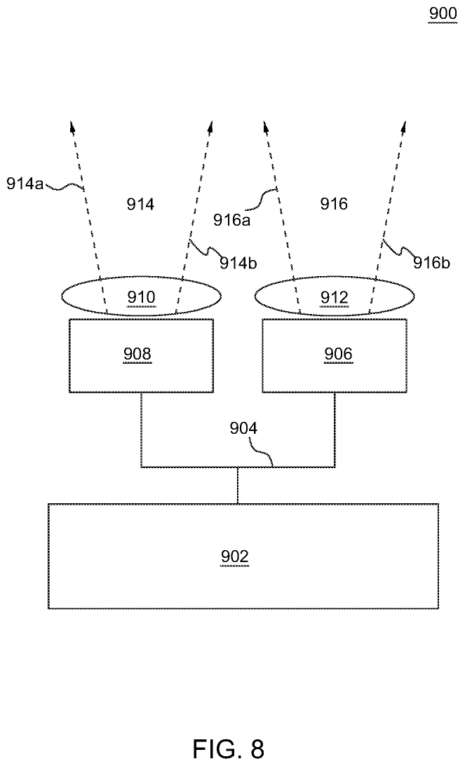

FIG. 3(b) is a diagram of another example automotive lighting system 430 incorporating separate near ultraviolet LEDs 412 and white LEDs 414 using the same reflector 410. In such an embodiment, the existing optics in the vehicle can be used, making the embodiment simpler to implement. In this case, the white LEDs 414 are located at the original position optimized for a good headlamp beam while the near ultraviolet LEDs 412 are located in such an off-focus position that their light is spread to a wider angle and especially to areas where pedestrians or other objects are expected. While two separate LEDs 412 and 414 are shown in FIG. 3(b), this embodiment may make use of a package that includes both near ultraviolet dies and white dies. Examples of a single package with both near ultraviolet and white dies are shown in FIGS. 6 and 7 and described in more detail below.

FIG. 3(c) is a diagram of another example automotive lighting system 450 incorporating separate near ultraviolet LEDs 418 and white LEDs 420 using separate reflectors 422 and 424. As with the embodiment illustrated in FIG. 3(a), here, if a different optic is used for the near ultraviolet LED 418, it may be possible to widen the beam that includes the near ultraviolet spectrum even further using optics designed for that purpose that may enable the near ultraviolet light to be spread even to areas where visible light is prohibited. Further, similar to the embodiment illustrated in FIG. 3(a), it is possible to use the vehicle's existing high beam optics as the reflector 422 alternatively to using optics designed specifically for the near ultraviolet LED 418.

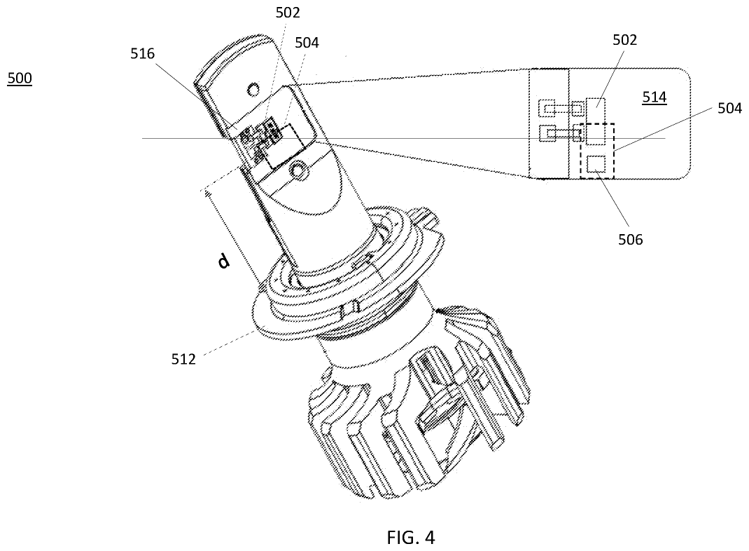

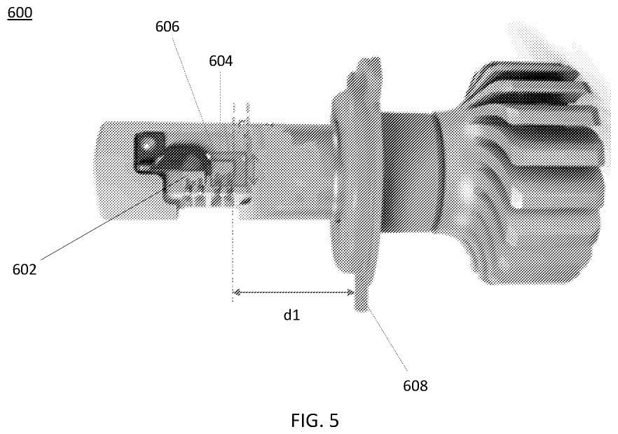

FIG. 4 is a diagram of an example retrofit lamp 500 for a single filament lamp incorporating a separate near ultraviolet LED 506 next to the white LED 502. In the example illustrated in FIG. 5, white LED 502 is disposed on a mounting region 514 of a heat sink 516. In some embodiments, the white LED 502 is adhered directly to the heat sink 516 using an adhesive glue or thermal adhesive, for example.

The retrofit lamp 500 may also include a centering ring 512, which may be used to mechanically couple the retrofit lamp 500 to a vehicle and may be used to align the white LED 502 to the optical axis of the retrofit lamp 500. For proper alignment of the white LED 502 such that the white LED 502 may operate as though it were the filament in a halogen lamp, a particular spacing “d” must be maintained between the edge of the white LED 502 and the reference surface as defined in IEC 60061 (in this example for an H7 lamp located on the centering ring 512) for a single filament lamp (e.g., H7, H11, HIR2, and HB3/4).

In order to incorporate a second LED for the near ultraviolet spectrum, the near ultraviolet LED 506 must be offset at least somewhat respect to the position of the LED 502. As it is desirable to project the near ultraviolet light in as wide a beam as possible, it may be desirable, in any event, to offset the ultraviolet LED 506 from the white LED 502 such that the lower edge of the ultraviolet LED 506 is located between d minus 3 mm and d plus 2 mm (in the axial direction). It may also be desirable to disclocate the ultraviolet LED 506 in the lateral direction with respect to the axis of the lamp by approximately 0.5 mm to approximately 2.0 mm (approximated as region 504 in FIG. 5). This may offset the ultraviolet LED 506 with respect to the existing lamp optics, defocusing the light emitted by the near ultraviolet LED 506 and thereby energizing a larger area with the near ultraviolet photons than the white photons.

FIG. 5 is a diagram of an example retrofit lamp 600 for a double filament lamp incorporating a separate near ultraviolet LED (not shown) in addition to the white LEDs 602 and 604. In the double filament retrofit lamp 600, white LEDs 602 and 604 are located where the two filaments would be in a double filament halogen lamp (e.g., H4 or HB2). The white LEDs 604 may be used for high beams with the corresponding optics, and the white LEDs 602 may be used for low beams with the corresponding optics, for example. The two white LEDs 602 and 604 may be coupled to a heat sink and electrically coupled to a power inlet for the retrofit lamp 600 via a flexible top bond similar to the embodiment illustrated in FIG. 5.

The retrofit lamp 600 may also include a ring 608, which may be used to mechanically couple the retrofit lamp 600 to a vehicle and may be used to align the white LEDs 602 and 604 to the optical axis of the retrofit lamp 600. For proper alignment of the white LEDs 602 and 604 such that they may operate as though they were the filaments in a double filament halogen lamp, a particular spacing d1 must be maintained between the white LED 604 and the centering ring 608 for a double filament lamp (e.g., H4).

In order to incorporate a third LED for the near ultraviolet spectrum, the near ultraviolet LED (not shown) must be offset at least somewhat respect to d1. As it is desirable to project the near ultraviolet light in as wide a beam as possible, it may be desirable, in any event, to offset the ultraviolet LED (not shown) with respect to the optical axis of the lamp such as by locating the ultraviolet LED (not shown) close to the high beam LED displaced from the high beam LED position not more than plus or minus 2 mm in the lateral direction and displaced from the high beam LED in the axial direction by not more than 3 mm towards the lamp base (approximated as region 606 in FIG. 6). This enables the near ultraviolet light from the near ultraviolet LED (not shown) to use the high beam part of the headlamp reflector to generate a high beam like emission, but defocusing the light emitted by the near ultraviolet LED (not shown) and thereby energizing a larger area with the near ultraviolet photons than the white photons.

FIG. 6 is a diagram of an example near ultraviolet and white light emitting LED 700. In the example illustrated in FIG. 6, the LED 700 includes a substrate 702, a white emitting LED 704 above substrate 702, and a near ultraviolet emitting LED 706 above the white LED 704. As used herein, “above” includes an element being mounted directly on another element, mounted on another element with something between the two and/or disposed above the other element in some other fashion. The substrate 702 may be a submount of a circuit board.

The white emitting LED 704 may have a peak wavelength greater than 440 nm, such as between 430 nm and 480 nm (e.g., 455 nm). White emitting LED 704 includes a blue emitting LED die 708 and a wavelength converter 710 above the blue LED die 708. The blue emitting LED die 708 may be a vertical or a thin-film flip-chip (TFFC) die that is formed on a patterned sapphire substrate (PSS).

The near ultraviolet emitting LED 706 may be located above the wavelength converter 710. The near ultraviolet emitting LED 706 may emit near ultraviolet light onto the wavelength converter 710, which may scatter and emit the near ultraviolet light with the white light. In some cases, the wavelength converter 710 may include phosphors (e.g., red phosphors) that may absorb part of the near ultraviolet light and emit a red light. The near ultraviolet emitting LED 706 may have a peak wavelength less than 430 nm, such as between 400 nm and 415 nm (e.g., 405 nm). The near ultraviolet LED die 706 may be a lateral die having electrical contacts on a top side of the die, which may be electrically coupled (e.g., by bonding wires) to contacts in the substrate 702.

The wavelength converter 710 may include yellow-green phosphors, red phosphors, or a combination of yellow-green and red phosphors. Wavelength converter 710 may be a YAG ceramic phosphor plate.

To increase luminance, the LED 700 may include a reflective side coating 712 on lateral surfaces of the white emitting LED 704 (e.g., on lateral surfaces of the blue emitting LED die 708 and the wavelength converter 710).

FIG. 7 is a diagram of another example near ultraviolet and white light emitting LED package 800. In the example illustrated in FIG. 7, the LED 800 may include at least a first LED 801 and a second LED 802. The first LED 801 may be configured to mainly emit blue light (e.g., 440 nm to 460 nm wavelength), and the second LED 802 may be configured to emit light in a range between 400 nm to 460 nm wavelength.

In the example illustrated in FIG. 7, a wavelength converting member 804 that includes a wavelength converting material may be arranged remotely from both the first LED 801 and the second LED 802 to receive light emitted by both LEDs 801 and 802. The wavelength converting member 804 may be referred to as a remote phosphor or as being in remote configuration. The wavelength converting member 804 may also be referred to as a remote phosphor layer. The wavelength converting member 804 may be self-supporting and may be provided in the form of a sheet, a plate, a disc, or similar. Although not shown in FIG. 7, the wavelength converting member 804 may be supported by one or more side walls surrounding the LEDs 801 and 802, such that the wavelength converting member 804 may form a lid or a window.

The wavelength converting material contained in the wavelength converting member 804 may be adapted to convert blue light into light of longer wavelengths, such as in the green to red spectral range, such that the resulting combination of blue light (e.g., 440 nm to 460 nm wavelength) and green to red light may be perceived as white. Thus, light emitted by the first LED 801 may be received by the wavelength converting member 804 and may be partially converted, whereas light emitted by the second LED 802, which is received by the wavelength converting member 804, may not be substantially converted, but rather transmitted. The LED package 800 may hence yield white output light having an additional emission peak in the wavelength range from 400 to 440 nm, which may result from the second LED 802.

In some embodiments, the wavelength converting member 804 may include a wavelength converting material having an absorption maximum above 450 nm, such as approximately 455 nm. One example of such material is YAG:Ce. In such embodiments, the second LED 802 may have an emission peak at or near 440 nm, which, due to the higher absorption wavelength of the wavelength converting material may still avoid too much conversion of light emitted by the second LED 802, such as light having wavelengths below approximately 435 nm.

In other embodiments, the wavelength converting member 804 may include a wavelength converting material having an absorption maximum below 450 nm, such as at or around 445 nm. On example of such material is LuAG:Ce.

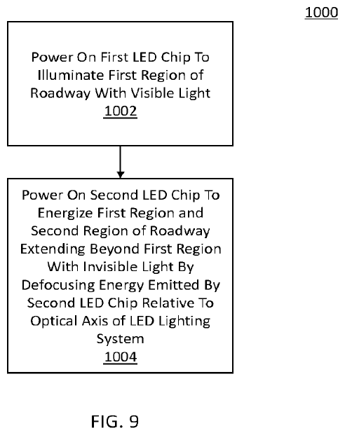

FIG. 8 is a diagram of an example vehicle headlamp system 900. The example vehicle headlamp system 900 illustrated in FIG. 9 includes an application platform 902, two LED lighting systems 906 and 908, and secondary optics 910 and 912.

The LED lighting system 908 may emit light beams 914 (shown between arrows 914a and 914b in FIG. 9). The LED lighting system 906 may emit light beams 916 (shown between arrows 916a and 916b in FIG. 9). In the embodiment shown in FIG. 8, a secondary optic 910 is adjacent the LED lighting system 908, and the light emitted from the LED lighting system 908 passes through the secondary optic 910. Similarly, a secondary optic 912 is adjacent the LED lighting system 906, and the light emitted from the LED lighting system 906 passes through the secondary optic 912. In alternative embodiments, no secondary optics 910/912 are provided in the vehicle headlamp system.

Each LED lighting system 906/908 may include an arrangement similar to FIG. 3(a), FIG. 3(b), FIG. 3(c), FIG. 4, FIG. 5 or other similar variation. In some embodiments, only one of the LED lighting systems 906 and 908 may include a near ultraviolet LED or a combination near ultraviolet and blue LED, such as described above.

Where included, the secondary optics 910/912 may be or include one or more light guides. The one or more light guides may be edge lit or may have an interior opening that defines an interior edge of the light guide. LED lighting systems 908 and 906 may be inserted in the interior openings of the one or more light guides such that they inject light into the interior edge (interior opening light guide) or exterior edge (edge lit light guide) of the one or more light guides. In embodiments, the one or more light guides may shape the light emitted by the LED lighting systems 908 and 906 in a desired manner, such as, for example, with a gradient, a chamfered distribution, a narrow distribution, a wide distribution, or an angular distribution.

The application platform 902 may provide power and/or data to the LED lighting systems 906 and/or 908 via lines 904, which may include one or more or a portion of the vehicle power lines and data bus. One or more sensors may be internal or external to the housing of the application platform 902. Alternatively, or in addition, each LED lighting system 908 and 906 may include its own sensor module, connectivity and control module, power module, and/or LED array.

In embodiments, the vehicle headlamp system 900 may represent an automobile with steerable light beams where LEDs may be selectively activated to provide steerable light or with non-steerable light beams. For an example using steerable light beams, an array of LEDs or emitters may be used to define or project a shape or pattern or illuminate only selected sections of a roadway. In an example embodiment, infrared cameras or detector pixels within LED lighting systems 806 and 808 may be sensors that identify portions of a scene (e.g., roadway or pedestrian crossing) that require illumination.

FIG. 9 is a flow diagram of an example method 1000 of operating an LED lighting system such as the system of FIG. 3(a), 3(b), 3(c), 4 or 5. In the example illustrated in FIG. 9, the method includes powering on a first LED o illuminate a first region of a roadway with visible light (1002). A second LED may be powered on to energize the first region of the roadway along with a second region of the roadway that extends beyond the first region of the roadway with invisible light by defocusing energy emitted by the second LED with respect to an optical axis of the LED lighting system (1004). In some embodiments at least some energy emitted by the second LED energizes fluorescent agents in at least one object in or near the roadway such that the at least one object emits light that includes, red, yellow, green and blue components when energized by the second LED. The visible light may include photons with wavelengths in a range between approximately 440 nm and approximately 495 nm. The invisible light may include photons with wavelengths in a range between approximately 415 nm and approximately 440 nm. One of ordinary skill in the art will understand that, while shown in a particular order in FIG. 10, the steps in the method can be performed in any order, including turning both the first and second LEDs on at the same time or turning them on in reverse order.

As would be apparent to one skilled in the relevant art, based on the description herein, embodiments of the present invention can be designed in software using a hardware description language (HDL) such as, for example, Verilog or VHDL. The HDL-design can model the behavior of an electronic system, where the design can be synthesized and ultimately fabricated into a hardware device. In addition, the HDL-design can be stored in a computer product and loaded into a computer system prior to hardware manufacture.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

1. A light-emitting diode (LED) lighting device comprising:
a substrate;
a white LED on the substrate at a location configured for alignment with an optical axis of an automotive lamp when installed; and
a near ultraviolet LED on the substrate at a location spaced apart from the white LED by an amount such that the near ultraviolet LED is defocused from the optical axis of the automotive lamp when installed such that the near ultraviolet LED emits energy in the near ultraviolet band in a larger area than the white LED when powered on.

2. The LED lighting device of claim 1, wherein:
the LED lighting device further comprises a centering ring, and
the white LED is configured to emit light in a wavelength range between approximately 440 nm and approximately 495 nm when powered on, and is spaced apart by a distance D from a reference surface on the centering ring that aligns the white LED with an optical axis of the LED lighting device.

3. The LED lighting device of claim 2, wherein the near ultraviolet LED is offset from the centering ring by a distance in the range of D minus 3 mm to D plus 2 mm.

4. The LED lighting device of claim 2, wherein the substrate is mechanically coupled to a member that is disposed through the centering ring.

5. The LED lighting device of claim 1, wherein the near ultraviolet LED is configured to emit enough energy in a wavelength range between approximately 400 nm and approximately 440 nm when powered on to activate fluorescent agents in objects in the larger area.

6. The LED lighting device of claim 1, wherein the LED lighting device is an LED retrofit device configured to replace a single filament halogen bulb.

7. The LED lighting device of claim 1, wherein the near ultraviolet LED is an LED package that comprises at least some LEDs configured to emit in the wavelength between approximately 440 nm and approximately 495 nm.

8. The LED lighting device of claim 1, further comprising a first optical element, wherein the white LED is aligned with an optical axis of the first optical element, and wherein the first optical element is at least one of a total internal reflection (TIR) lens or a reflector.

9. The LED lighting device of claim 1, wherein the white LED and the near ultraviolet LED share a common second optical element.

10. A method of operating a light-emitting diode (LED) lighting system, the method comprising:
powering on a first LED to illuminate a first region of a roadway with visible light; and
powering on a second LED to energize the first region of the roadway and a second region of the roadway that extends beyond the first region of the roadway with invisible light by defocusing energy emitted by the second LED with respect to an optical axis of the LED lighting system

11. The method of claim 10, wherein at least some energy emitted by the second LED energizes fluorescent agents in at least one object in or near the roadway such that the at least one object emits light that includes red, yellow, green and blue components when energized by the second LED.

12. The method of claim 10, wherein the visible light includes photons with wavelengths in a range between approximately 440 nm and approximately 495 nm.

13. The method of claim 10, wherein the invisible light includes photons with wavelengths in a range between approximately 400 nm and approximately 440 nm.

14. A light-emitting diode (LED) lighting device comprising:
an optical element;
a centering ring;
a first white LED on a substrate, the first white LED being aligned with an optical axis of the optical element;
a second white LED spaced apart on the substrate from the first white LED and aligned with an optical axis of the LED lighting device; and
a near ultraviolet LED defocused from the optical element such that the near ultraviolet LED emits energy in the near ultraviolet band in a wider area than the first and second white LEDs.

15. The LED lighting device of claim 14, wherein the second white LED is spaced apart by a distance D from a reference surface on the centering ring that aligns the first white LED with an optical axis of the LED lighting device.

16. The LED lighting device of claim 14, wherein the near ultraviolet LED is spaced apart from the reference surface on the centering ring by a distance in the range of D to D minus 3mm and offset from the second white LED by up to plus or minus 2 mm in the lateral direction.

17. The LED lighting device of claim 14, wherein at least one of the first white LED and the second white LED are configured to emit light in a wavelength range between approximately 440 nm and approximately 495 nm when powered on.

18. The LED lighting device of claim 14, wherein the near ultraviolet LED is configured to emit energy in a wavelength range between approximately 400 nm and approximately 440 nm when powered on.

19. The LED lighting device of claim 14, wherein the LED lighting device is an LED retrofit device configured to replace a double filament halogen bulb.

20. The LED lighting device of claim 19, wherein the substrate is mechanically coupled to a member that is disposed through the centering ring.
